(19) United States
(12) Patent Application Publication
(10) Pub. No.: US 2026/0339807 A1
(43) Pub. Date: Oct. 29, 2026

(54) Global Score Index for Normalized Cross-Network Influence Benchmarking

(71) Applicant: George William Bickerstaff, III, Greenwich, CT (US)

(72) Inventor: George William Bickerstaff, III, Greenwich, CT (US)

(21) Appl. No.: 19/308,289

(22) Filed: Aug. 24, 2025

(51) Int. Cl. G06F 11/34

(52) U.S. Cl. CPC G06F 11/3428; G06F 11/3452

(57) ABSTRACT

A Global Score Index generates a unified influence index by aggregating metrics from diverse platforms, normalizing them with statistical algorithms, calibrating for sector and regional variations, and delivering outputs via a secure application programming interface. The system includes a score aggregation gateway, a normalization and weighting engine, a calibration matrix, a composite index compiler, and a benchmarking interface. A method ingests scores, normalizes and weights them, calibrates for contextual factors, compiles indices, and outputs benchmarks for investment, governance, or eligibility applications, ensuring comparability and transparency across siloed networks.

### FIELD OF THE INVENTION

This invention relates to data processing systems for aggregating, normalizing, and benchmarking influence, trust, and alignment metrics across digital platforms, enabling cross-network comparisons for governance and investment applications.

### BACKGROUND OF THE INVENTION

Influence, trust, and reputation metrics from platforms such as social media or professional networks are siloed and inconsistent, hindering cross-network comparisons for applications such as governance or investment. Prior art lacks mechanisms for unified normalization and calibration, often failing to provide statistically rigorous cross-platform benchmarking that accounts for sector-specific and regional variations. While some attempts have been made at cross-platform analytics, they typically focus on narrow domains such as security threats, sentiment aggregation, or malicious activity detection, without integrating diverse influence metrics into a normalized, calibrated, and portable composite index suitable for broad applications such as investment decision-making or eligibility assessments.

The following prior art and their limitations highlight the absence of comprehensive normalization, contextual calibration, and unified benchmarking:

| Reference | Document No. | Description | Limitation |
|---|---|---|---|
| U.S. Pat. No. 9,632,972B1 | U.S. Pat. No. 9,632,972B1 | Determining | Calculates single-community |
| (2017) | | influence in a | influence, not cross-network; |
| | | social | lacks normalization and |
| | | networking | calibration for contextual |
| | | system | factors. |
| U.S. Pat. No. 9,294,576B2 | U.S. Pat. No. 9,294,576B2 | Social media | Domain-specific to media |
| (2016) | | impact | influence metrics; no cross- |
| | | assessment | platform aggregation or |
| | | | statistical normalization. |
| U.S. Pat. No. 8,214,497B2 | U.S. Pat. No. 8,214,497B2 | Multi- | Focuses on distributed |
| (2012) | | dimensional | reputation for |
| | | reputation | communication entities in |
| | | scoring | security contexts; lacks |
| | | | cross-platform influence |
| | | | metric integration, |
| | | | normalization to unified |
| | | | scales, or calibration for |
| | | | sectors/regions. |
| U.S. Pat. No. 8,977,631B2 | U.S. Pat. No. 8,977,631B2 | Visualization of | Primarily visualizes feedback |
| (2015) | | reputation | via term frequency and |
| | | ratings | emoticons; no cross-platform |
| | | | data aggregation, statistical |
| | | | normalization, or contextual |
| | | | calibration. |
| US20220383142A1 | US20220383142A1 | Machine | Detects coordinated |
| (2022) | | learning based | malicious influence across |
| | | prediction of | platforms; includes text |
| | | social media | normalization in |
| | | influence | preprocessing but lacks |
| | | operations | unified statistical |
| | | | normalization for general |
| | | | influence scoring and |
| | | | calibration for sector/region |
| | | | variations. |
| US20100119053A1 | US20100119053A1 | Analytic | Aggregates conversations |
| (2010) | | measurement of | from multiple sources for |
| | | online social | sentiment quantification; |
| | | media content | handles cross-platform data |
| | | | but without rigorous |
| | | | normalization to comparable |
| | | | scales or calibration for |
| | | | industry/geographic norms. |

These prior arts, while advancing aspects of reputation or influence analysis, fall short of providing a holistic system for cross-network benchmarking. Systems such as U.S. Pat. No. 8,214,497B2 aggregate reputations but do so without transforming heterogeneous metrics into a standardized scale via methods such as z-scoring or percentile ranking, nor do they apply dynamic weighting or contextual adjustments essential for fair comparisons across diverse sectors and regions. Cross-platform efforts in US20220383142A1 and US20100119053A1 are limited to specific analytics such as threat detection or sentiment trends, lacking composite index compilation and secure API delivery for real-world applications. This invention addresses these gaps by introducing a framework with statistical normalization, multi-factor calibration, and portable benchmarking, enabling comparability and transparency in cross-network influence evaluation.

### SUMMARY OF THE INVENTION

The Global Score Index provides a computerized system and method for generating a global index of influence by aggregating metrics from diverse platforms, normalizing them with statistical algorithms, calibrating for sector and regional variations, compiling composite indices, and delivering outputs via a secure API. The system includes a score aggregation gateway, a normalization and weighting engine, a calibration matrix, a composite index compiler, and a benchmarking API. The method involves ingesting scores, normalizing and weighting them, calibrating for contextual factors, compiling indices, and outputting benchmarks for applications such as investment scoring, governance, and eligibility determination. Novel advantages over prior art include unified cross-domain benchmarking with rigorous statistical normalization and contextual calibration, enhanced comparability across siloed platforms, score portability for diverse applications, dynamic adaptation to sector and regional variations, and improved data transparency through auditable processes and secure delivery.

### BRIEF DESCRIPTION OF THE DRAWINGS

The drawings illustrate embodiments of the invention and are submitted as separate sheets in compliance with 37 CFR 1.81.

FIG. 1: Illustrates a block diagram of the System Architecture Overview, showing the flow of data through the score aggregation gateway [100], data inputs [110], normalization and weighting engine [120], calibration matrix [130], composite index compiler [140], benchmarking API [150], and data outputs [160].

FIG. 2: Depicts the Score Normalization and Conversion Pipeline, including raw input processing [200], z-scoring [210], percentile ranking [220], dynamic weighting [230], and standardized outputs [240].

FIG. 3: Shows the Sector and Region Calibration Engine, including matrices for domain adjustments [300], industry classifications [310], geographic metadata [320], regression models [330], and lookup tables [340].

FIG. 4: Illustrates the Composite Index Compilation Workflow, including weighted inputs [400], continuous scores [410], tiered ranks [420], ARIMA forecasting [430], and final index formats [440].

FIG. 5: Depicts the Flowchart of Benchmarking Output and API Processes, including query handling [500], individual scores [510], peer benchmarks [520], analytics [530], and encrypted delivery [540].

### DEFINITIONS

For clarity and to ensure accurate interpretation, the following terms are defined as used in this specification (sorted alphabetically):
Alignment Metrics: Measures of relevance or compliance, such as sector-specific expertise or regulatory adherence, computed semantically.
API: Application Programming Interface for secure data exchange in formats such as JSON or XML.
ARIMA: Autoregressive Integrated Moving Average, a statistical model for time-series forecasting.
Composite Index: A unified score integrating normalized and calibrated inputs, output in continuous or tiered formats.
GDPR: General Data Protection Regulation, an EU framework for data privacy compliance.
Influence Metrics: Quantitative measures of an entity's impact, such as engagement rates or citation indices.
JSON/XML: Standard data formats for API outputs, enabling interoperability.
Normalization: Statistical transformation of data into a common scale (e.g., 0-1000) using z-scoring or percentile ranking.
Percentile Ranking: Mapping a score to a 0-100 scale based on its distribution position.
PowerRank: A platform-specific influence scoring system used as an example input.
Rebalancing: Periodic index updates to incorporate new data or refinements.
Region Calibration: Score adjustments for geographic or cultural differences using metadata or IP geolocation.
Sector Calibration: Score adjustments based on industry norms, using codes such as NAICS.
Tokenization: A privacy-preserving technique replacing sensitive data with unique identifiers.
Trust Metrics: Indicators of reliability, including verified credentials or peer endorsements.
Z-Scoring: A statistical method where z=(x−μ)/σ, with x as the raw score, μ as the mean, and σ as the standard deviation.

### DETAILED DESCRIPTION OF THE INVENTION

This section explains how to make and use the invention, with references to the drawings. Modifications are possible within the scope.

### System Overview

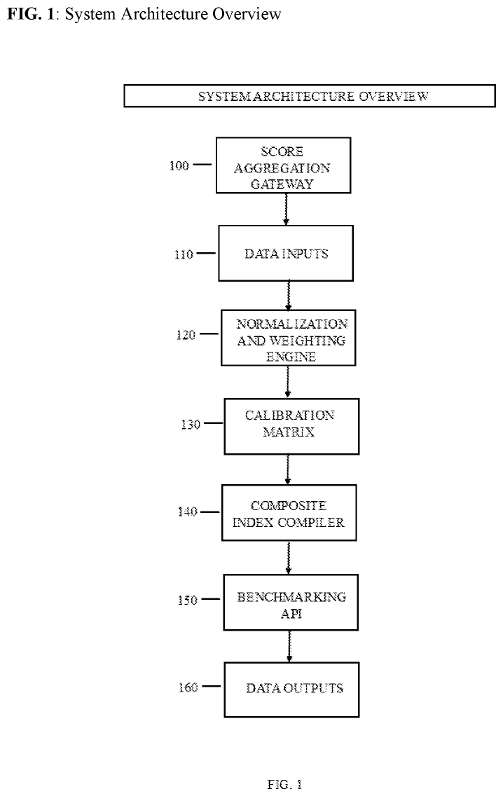

As shown in FIG. 1 with reference 100, the Global Score Index (GSI) unifies heterogeneous metrics into a standardized index, operating on processors in a cloud or distributed environment.

### Core Components

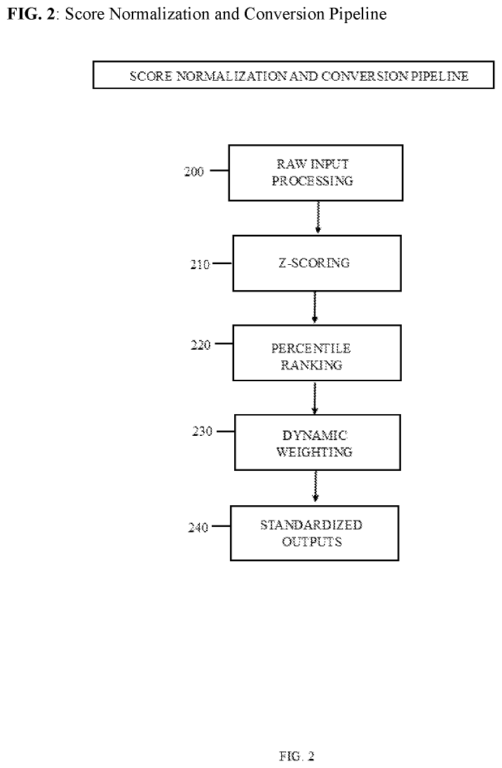

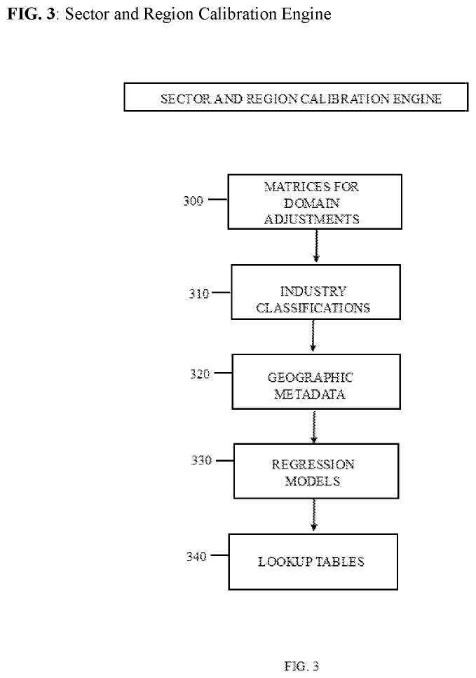

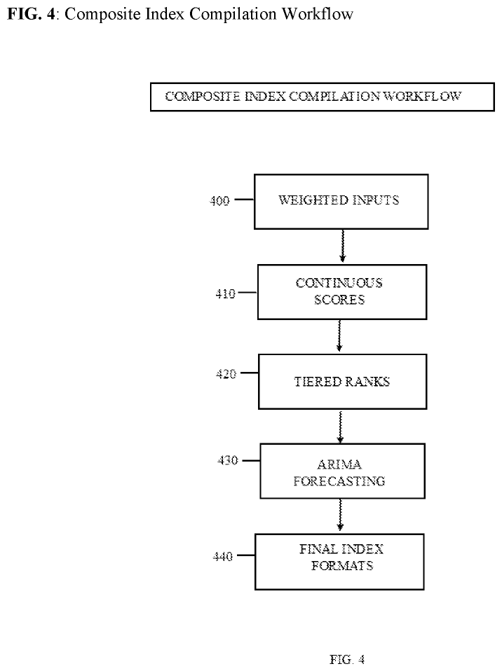

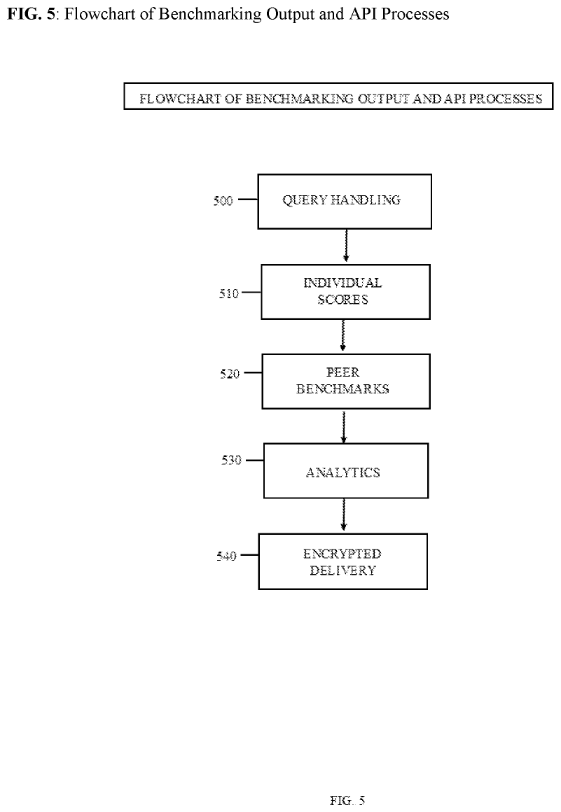

1. Score Aggregation Gateway. Illustrated in FIG. 1 with reference 100, this gateway collects metrics (e.g., PowerRank, trust scores) via APIs or batch uploads (reference 110), ensuring GDPR compliance through encryption and tokenization. It filters conflicting data based on source reliability.
2. Normalization and Weighting Engine. As shown in FIG. 2 with reference 120, this engine standardizes scores using z-scoring (z=(x−μ)/σ; verified: x=75, μ=50, σ=10, z=2.5) or percentile ranking, scaling to 0-1000. Weights are assigned dynamically (e.g., 0.6 for verified sources).
3. Sector and Region Calibration Matrix. Depicted in FIG. 3 with reference 130, this matrix adjusts scores for industry (e.g., NAICS codes) and geographic norms, using regression models or lookup tables, updated annually.
4. Composite Index Compiler. Shown in FIG. 4 with reference 140, this compiler synthesizes scores into continuous (0-1000) or tiered indices, rebalanced quarterly with ARIMA forecasting for trends.
5. Benchmarking API. As shown in FIG. 5 with reference 150, this API delivers outputs in JSON/XML or dashboards, supporting real-time queries for investment or governance, with encrypted delivery.

### Operational Method

The GSI operates by:
1. Ingesting metrics through the score aggregation gateway (FIG. 1 with reference 100).
2. Normalizing and weighting scores (FIG. 2 with reference 120).
3. Calibrating for sector/region (FIG. 3 with reference 130).
4. Compiling indices (FIG. 4 with reference 140).

5. Delivering via benchmarking API (FIG. 5 with reference 150).

### Advantages

The GSI ensures comparability, portability, and transparency across diverse platforms.

### NOTE ON CLAIMS AND ABSTRACT

The claims and abstract are submitted on separate sheets in compliance with 37 CFR 1.75(h), 1.72(b), and 1.121, and are provided as accompanying DOCX documents in this response.

What is claimed is:

1. A computerized system for generating a global index of influence, comprising: one or more processors; and memory storing instructions that, when executed, cause the system to: aggregate influence scores from diverse platforms via a score aggregation gateway; normalize the aggregated scores into a unified scale using statistical methods; calibrate the normalized scores based on sector and region-specific factors using a calibration matrix; compile a composite index from the calibrated scores; and provide the composite index via a benchmarking API.

2. A computer-implemented method for creating a global index of influence, comprising: ingesting influence scores from diverse platforms; normalizing the ingested scores into a unified scale using statistical transformations; calibrating the normalized scores by applying sector and region-specific adjustments using a calibration matrix; compiling a composite influence index from the calibrated scores; and outputting the composite index for benchmarking via an API.

3. A non-transitory computer-readable storage medium storing instructions that, when executed by a processor, cause performance of a method for creating a global index of influence, comprising: ingesting influence scores from diverse platforms; normalizing the ingested scores into a unified scale using statistical transformations; calibrating the normalized scores by applying sector and region-specific adjustments using a calibration matrix; compiling a composite influence index from the calibrated scores; and outputting the composite index for benchmarking via an API.

4. The system of claim 1, wherein the aggregated scores include influence, trust, and alignment metrics from verified sources including social networks.

5. The system of claim 1, wherein the normalization includes statistical transformations and weighting algorithms, scaled to a unified range.

6. The system of claim 1, wherein the calibration matrix adjusts scores using industry and geographic norms.

7. The system of claim 1, wherein the composite index is generated in tiered or continuous formats with periodic rebalancing.

8. The system of claim 1, wherein the benchmarking API outputs are used for investment scoring or governance applications in real time.

9. The system of claim 1, wherein the instructions update the composite index at predefined frequencies with bias audits.

10. The system of claim 1, wherein the normalization assigns weights based on source reliability using machine learning models.

11. The method of claim 2, wherein ingesting includes collecting data from influence and trust systems with privacy-preserving techniques.

12. The method of claim 2, wherein normalizing uses statistical transformations for consistency.

13. The method of claim 2, wherein calibrating applies industry and geographic adjustments.

14. The method of claim 2, wherein compiling produces outputs with trend analysis.

15. The method of claim 2, further comprising rebalancing the index periodically to ensure comparability.

16. The method of claim 2, wherein outputting supports investment and governance applications with encrypted delivery.
